(19) United States
(12) Patent Application Publication
(10) Pub. No.: US 2022/0048596 A1
(43) Pub. Date: Feb. 17, 2022

(54) SureFill

(71) Applicant: Jerry Baccari, San Pedro, CA (US)

(72) Inventor: Jerry Baccari, San Pedro, CA (US)

(21) Appl. No.: 16/932,668

(22) Filed: Aug. 12, 2020

(51) Int. Cl. B63B 17/00; F02M 37/00; B63H 21/38

(52) U.S. Cl. CPC B63B 17/0036; B63H 21/38; F02M 37/0076

(57) ABSTRACT

The present invention relates to improvements to fill prevention devices and more particularly to a permanently installed fill prevention device used for potable water tanks. There are other fill prevention devices however because other fill prevention devices related to potable water systems require them to be removed before filling the water tank, these other devices are difficult to use and are often lost. The present invention discloses a circular disk (1) made from plastic such as Nylon, High Density Polypropylene, or other inert durable plastic. The outer area of the disk is threaded (3) to allow this fill prevention device to be threaded into existing potable water deck fill (7) When in place the device will prevent the insertion of a fuel nozzle, hence keeping the water tank and potable water contamination free. From the center of the circular disk is a hollow cylinder (2) which rises vertically and is connected to the inner wall of the circular disk. The diameter of this hollow cylinder is such so that the end of a garden hose (5) can be inserted over it to fill the water tank. Along the bottom edge of the device are holes (4) that allow air and excess water to escape. This device when inserted into an existing deckfill (7) creates both a mechanical barrier along with a visual deterrent due to it's blue color which is consistent with containers used for potable water.

This device when inserted still allows the existing deck cap (6) to be used.

This fill prevention device can also be manufactured into a deckfill (12) as shown in FIG. 7.

The advantage of having this device in place is to prevent the costly error of accidentally adding fuel to a watercrafts potable water system. This is an error that occurs often and results in irreparable damage to the watercrafts potable water tank resulting in thousands of dollars of damage; in most cases causing the need for expensive replacement of the watercrafts water tank system. There is also the creation of a hazardous waste material when mixing fuel within the water system. This will affect the need for proper hazardous waste disposal.

### TECHNICAL FIELD

The present invention relates to a fill prevention device and the improvements to the device which includes a permanent installation.

### BACKGROUND ART

There are other known fill prevention devices related to the watercraft deckfill. However because these other devices must be removed prior to filling they do not offer a permanent solution and are easily misplaced.

### SUMMARY OF THE INVENTION

An object of the present invention is to provide a device, when inserted into a deckfill typically used for water craft, will provide both a physical and visual deterrent to inserting a fuel nozzle into the deckfill.

Briefly stated this device consists of a circular disk with a raised outer edge of approximately ⅜″. The outer edge of this raised section is threaded to match the threads of existing watercraft deck fills. From the center of the disk a hollow cylinder rises vertically above the threaded portion, approximately ¾ of an inch. The diameter of this hollow cylinder is such that the end of a normal garden hose can be inserted over it, holding the garden hose in place. Along the bottom of the disk are openings. These openings allow air or excess water to escape, as the potable water system is being filled. (FIG. 1). Once threaded into the existing deck fill the existing deck fill cap can be used to seal the filler neck (FIG. 1). According to the present invention, when in place inserted into a typical deckfill the raised center hollow cylinder will prevent a typical fuel nozzle from being inserted into the deckfill.

Further, the blue coloring of the device corresponds to the color used for potable water containers will provide a visual deterrent to inserting a fuel nozzle.

Another embodiment ise the manufacture of watercraft deck fills with the described device permanently molded in place (FIG. 5).

### BRIEF DESCRIPTION OF DRAWINGS

FIG. 1 is a side view of the fill prevention device.

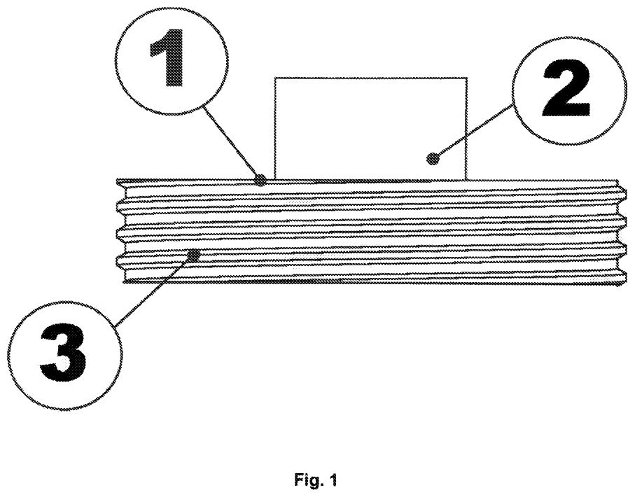

FIG. 2 is a top view of the fill prevention device of (FIG. 1).

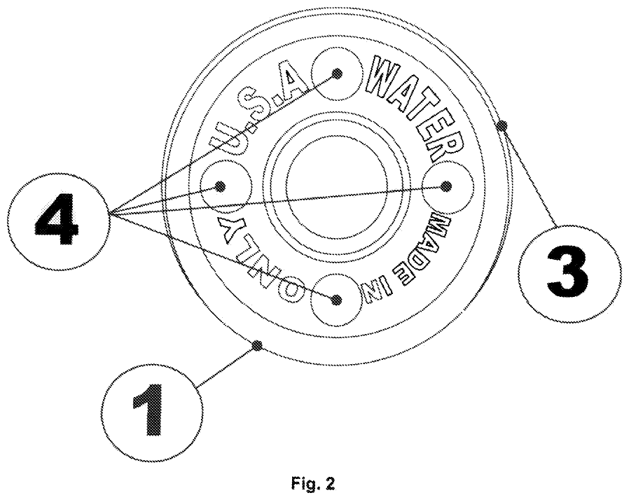

FIG. 3 is an orthographic view of the fill prevention device of (FIG. 1).

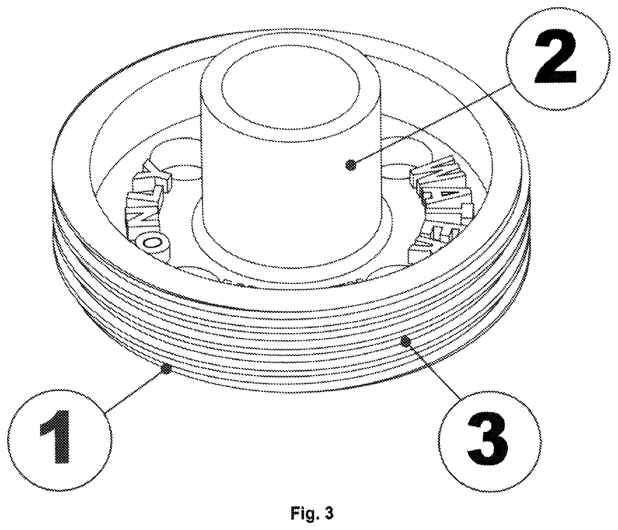

FIG. 4 is a cutaway view of device of the fill prevention device of (FIG. 1).

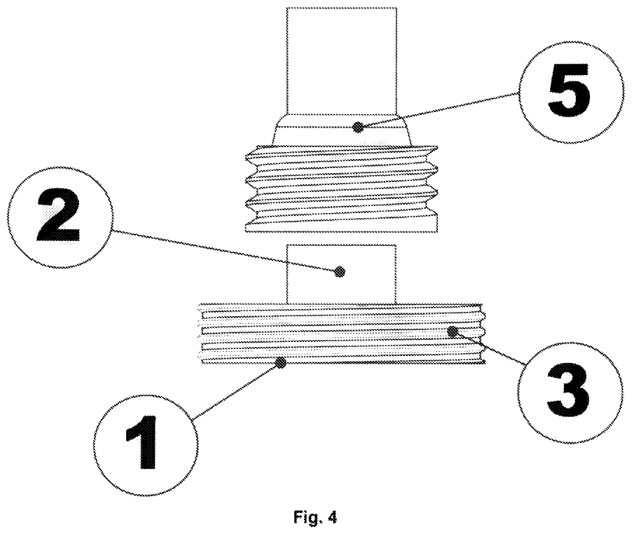

FIG. 5 is a side view representation of the fill prevention device of (FIG. 1).

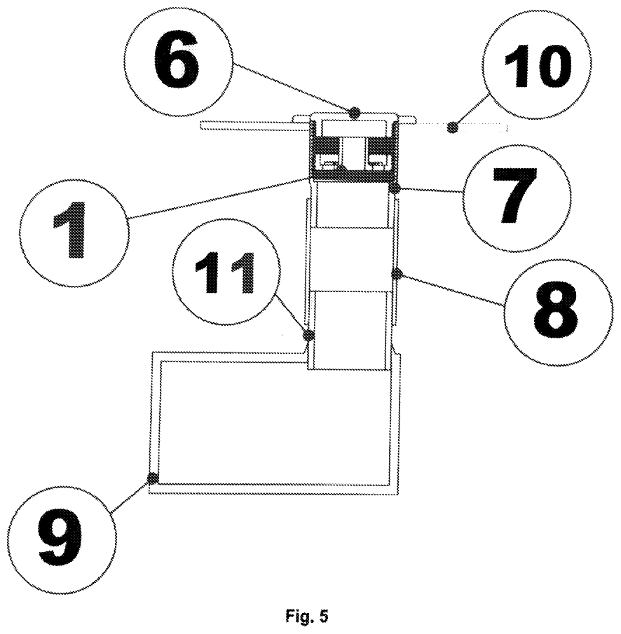

Showing the end of a garden hose about to be inserted over the hollow vertical cylinder of the fill prevention device of (FIG. 1).

FIG. 6 is a side cutaway view of an example of an installation of a watercrafts potable water storage system with the device of (FIG. 1) inserted in the deck fill.

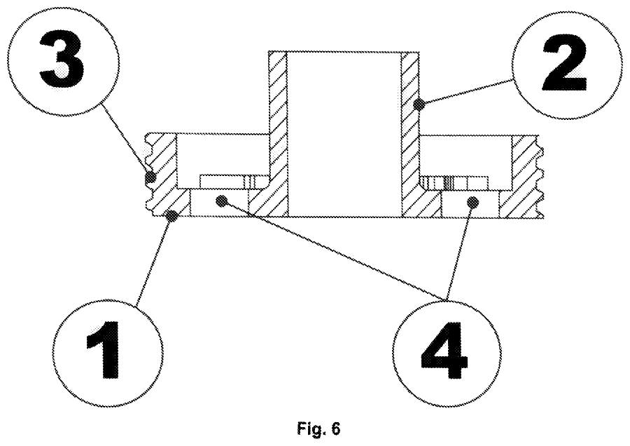

FIG. 7 is a side cutaway view of the fill prevention device of (FIG. 1), molded into a deck fill used for watercraft

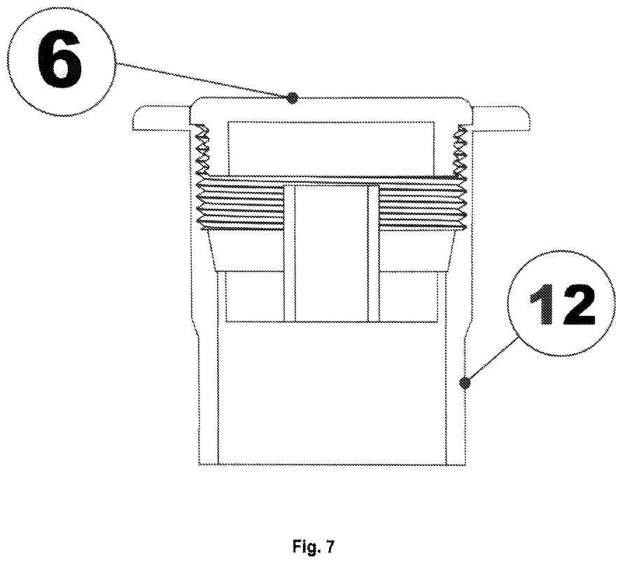

### DETAILED DESCRIPTION OF DRAWINGS

With reference to the drawings, like numerals represent like parts throughout said drawings. The SureFill device is designated by the numeral (1). The SureFill device is utilized to create both a mechanical and visual deterrent to inserting a fuel nozzle into a watercraft's potable water system. The SureFill device is a circular disk consisting of an outer threaded area (3). A hollow cylinder (2) rises vertically from the lower area and is centered within the disk (1). The diameter of this cylinder is sized to allow the end of a garden hose (5) to be inserted over it while filling the potable water tank (9). Along the bottom edge of the SureFill device (1) are a series of holes (4) that allow air and excess water to escape when filling the water tank (9). The SureFill device (1) is threaded into a deck fill (7) which is installed in the deck (10) of a watercraft. The SureFill (1) resides at the base of the deck fill (7) above the connecting hose (8) connecting the deck fill (7) to the potable water tank inlet (11) which is connected to the potable water tank (9). In this configuration the cap (6) normally used to seal the deck fill (7) can still be used.

In another preferred form of the SureFill (1) is molded permanently in the deck fill (11) at time of manufacture.

The invention claimed is:

1. A contamination Preventative Device comprising;
A hollow circular disk having external threads,
A Vertical hollow cylinder rising from the base of the circular disk, The cylinder being attached to the inside walls of the circular disk by equal length horizontal standoffs

2. A contamination Preventative Device in claim 1 wherein the diameter of said circular disk is consistent with the internal thread diameter of a typical watercraft deckfill

3. A contamination Preventative Device in claim 1 wherein said external threads are consistent with the threads used in typical watercraft deckfills

4. A contamination Preventative Device in claim 1 wherein said vertical cylinder's diameter is such to allow the end of a garden hose to be inserted over it, allowing water to pass through the device

5. A contamination Preventative Device in claim 1 wherein said color of circular disk is consistent with what is typically used to denote potable water containers

6. A contamination Preventative Device in claim 1 when inserted into the deckfill of a watercraft provides both a physical and visual deterrent to inserting a fuel nozzle

7. A contamination Preventative Device in claim 1 permanently part of a deckfill used for watercraft at time of manufacturing the deckfill.
